(19) United States
(12) Patent Application Publication
(10) Pub. No.: US 2004/0145327 A1
(43) Pub. Date: Jul. 29, 2004

(54) Method of operating the electric window lifters of a motor vehicle

(76) Inventors: Christian Gruber, Wolkertshofen (DE); Uwe Hainlin, Amtzell (DE); Helmut Marquardt, Herrenberg (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/472,118

(22) PCT Filed: Mar. 2, 2002
(86) PCT No.: PCT/EP02/02259

(30) Foreign Application Priority Data
Mar. 20, 2001 (DE) 101 13 318.9

(51) Int. Cl. H02P 3/00

(52) U.S. Cl. 318/283

(57) ABSTRACT

1. Method for operating the electric window openers of a motor vehicle.

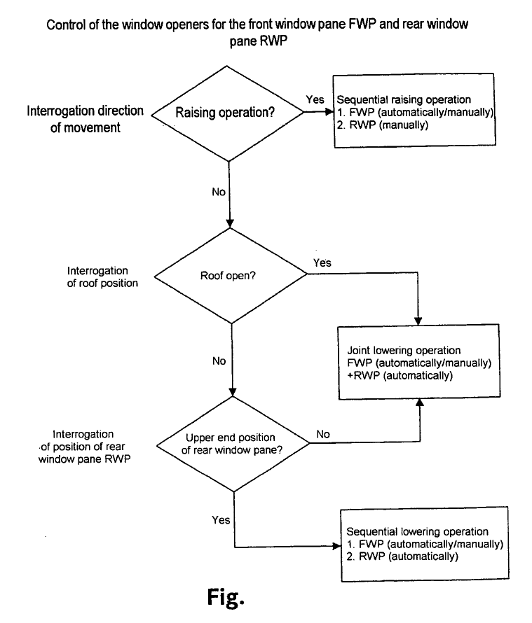

2.1 A simple, cost-effective and user-friendly method for sequentially controlling the action of the window openers for moving the front window pane and the rear window pane is proposed.

2.2 For this purpose, the window openers on one side of the motor vehicle are operated by the actuation of a single operating element. The sequence for moving the front window pane and the rear window pane is controlled as a function of the selection made by the operating element of the direction of movement and of the mode of movement of the window panes and of the position of the rear window pane; in the case of motor vehicles having a movable roof, the position of the roof of the motor vehicle is additionally used for the sequential control.

A method of operating the electric window openers of a motor vehicle. A simple, cost-effective and user-friendly method for sequentially controlling the action of the window openers for moving the front window pane and the rear window pane is proposed. For this purpose, the window openers on one side of the motor vehicle are operated by the actuation of a single operating element. The sequence for moving the front window pane and the rear window pane is controlled as a function of the selection made by the operating element of the direction movement and of the mode of movement of the window panes and of the position of the rear window pane; in the case of motor vehicles having a movable roof, the position of the roof of the motor vehicle is additionally used for the sequential control.

Electric driving units are used in motor vehicles in varied ways to bring about processes, which are carried out by means of external power, for actuating movable parts, for example for adjustment of seats or for opening and closing sliding roofs, sliding doors and, in particular, side windows of the motor vehicle. Electric driving units comprise an electric motor (for example, a d.c. motor) for generating and providing electric driving power, a transmission for translating the movement of the electric motor, a device for mechanically coupling or adapting the electric motor or transmission to the movable part (actuating element), in particular for converting the rotational movement of the electric motor into a linear movement, and an electronic module for activating and monitoring the electric motor (for example, for regulating the speed of rotation and power of the electric motor).

The actuating processes which are carried out by means of external power (by electric motor) can be carried out manually, by the operator continuously actuating an operating element, or, in order to increase the comfort, often also automatically by the operator now merely having to initiate the actuating process (for example, by actuating an operating element just once) and being able to attend to other activities during the actuating process which proceeds (fully) automatically. These modes of movement are implemented, in particular, in electric driving units for electrically actuating the window openers of the motor vehicle, which are used for bringing about the closing processes and opening processes of the side windows.

However, in motor vehicles in which both side windows on one side of the motor vehicle, i.e. both the front window and the rear window, can be operated from the front compartment either by the driver or by the front passenger of the motor vehicle, there is the problem that a multiplicity of operating elements are required, the operation of which overtaxes or distracts the operator and that, as a consequence of the (arbitrary and uncoordinated) movement of the window panes, a multiplicity of different and often annoying or undesirable positions of the window panes may occur. This is the case in particular in those motor vehicles in which the rear windows can be operated only from the front compartment, i.e. there is no possibility in the rear compartment of actuating the window panes (for example, in two-seaters, in motor vehicles with emergency seats in the rear compartment or in coupés), in which case visually unattractive positions of the window panes can occur, particularly in those motor vehicles in which the roof can be opened (for example, in convertibles or in roadsters).

The invention is based on the object of specifying a method for operating the electric window openers of a motor vehicle which makes it possible for the electric window openers to be actuated and therefore for the window panes to be moved without unnecessary restrictions in a simple manner and at low costs with nevertheless high reliability.

This object is achieved according to the invention by the features in the characterizing part of patent claim 1.

Advantageous developments of the method are part of the further patent claims.

The movement of the window panes of the motor vehicle (the front window panes and the rear window panes) is controlled in accordance with certain criteria using just one operating element which is provided for the two window panes of one side of the motor vehicle and is therefore assigned to one operator (i.e. to the driver or the front passenger of the motor vehicle); that is to say, when the particular operating element (designed, for example as a window opener switch) is actuated by the particular operator in order to activate the movement of the window panes, the front window panes and the rear window panes are moved in accordance with the provision of certain boundary conditions. The criteria used for controlling the movement of the window panes include, in the actuating process, in particular the direction of movement of the window panes, which is predetermined by actuation of the operating element, the mode of movement of the window panes, which is predetermined by actuation of the operating element, and the position of the window panes (the front window pane and the rear window pane) to be actuated; furthermore, it is optionally also possible, in particular in motor vehicles having a movable roof, to use the position (the open state or closed state) of the roof:

As actuating process, either an opening process or a closing process of the windows (the front window and the rear window) can be undertaken by the desired direction of movement of the window panes (the front window panes and the rear window panes) of the motor vehicle being selected by corresponding actuation of the operating element, i.e. either raising of the window panes to carry out a closing process of the windows or a lowering of the window panes to carry out an opening process of the windows.

The actuating process will be carried out either manually (as a manual function) or automatically (as an automatic function) by the desired mode of movement of the window panes (the front window panes and the rear window panes) of the motor vehicle being selected by corresponding actuation of the operating element, i.e. either the actuating process can be carried out manually, with the selected actuating process being executed for as long as the operating element is actuated, or the actuating process can be carried out automatically, with the selected actuating process automatically continuing after release of the operating element until the movement of the window pane is stopped (either by actuation of the operating element or by the window pane reaching the end position).

The position of the window pane can be either an end position or an intermediate position which is taken up by the window panes, the window being completely closed in the respective end position of the window pane (upper end position of the window pane when driven into the sealing frame) or completely opened (lower end position of the window pane when it strikes against the boundary block in the door frame), and, in an intermediate position of the window pane between the two end positions (between the upper end position and the lower end position), the window is only partially closed (window pane below the upper end position) or partially open (window pane above the lower end position).

The position of the roof of the motor vehicle, particularly in motor vehicles having a movable roof (i.e. in motor vehicles in which the roof can be opened), differentiates between the open state and the closed state of the roof, the roof being completely open in the open state and being completely closed in the closed state (this position of the roof is always provided in motor vehicles having an immovable roof).

These criteria (boundary conditions) predetermine the chronological sequence for the movement of the two window panes on one side of the motor vehicle, with, in particular, either a simultaneous movement of the two window panes on one side of the motor vehicle, i.e. the action of the window openers for the movement of the front window pane and of the associated rear window pane is processed simultaneously, or there being a sequential movement of the window panes on one side of the motor vehicle, i.e. first of all the action of the window openers and therefore the movement of the front window pane is processed until the latter has reached its end position and the corresponding rear window pane is only moved upon a request which still exists or is renewed at this point (in order to activate the movement of the rear window pane, at this point therefore either the operating element has to be actuated again or the operating element has to have continued being actuated at this time). The control of the movement of the window panes of the motor vehicle, which is dependent on the direction of movement and the mode of movement, is undertaken in this case as a function of the position in such a manner that a closing process of the windows (raising operation of the window panes) is always undertaken sequentially and an opening process of the windows (lowering operation of the window panes) only when the roof is closed and the rear window pane is in the upper end position is likewise undertaken sequentially, i.e. in these cases, first of all the front window pane of the front window selected by the operating element is moved (manually or automatically) to the (upper or lower) end position (manually or automatically raised or manually or automatically lowered) and then the corresponding rear window pane is moved (manually raised or automatically lowered) whereas an opening process of the windows (lowering operation of the window panes) is undertaken simultaneously either when the roof is open or when the roof is closed and the rear window pane is not in the upper end position, i.e. in these cases, the front window pane of the front window selected by the operating element is moved (manually or automatically) to the desired position (manually or automatically lowered) and at the same time the corresponding rear window pane is automatically moved (automatically lowered). In this connection, in the case of the rear window, only a manual raising operation of the rear window pane is possible whereas, in the case of the lowering operation of the rear window pane, an automatic action (an automatic lowering operation of the rear window pane) is always realized.

During each operating process, an efficient and convenient sequence which is matched to the operating conditions of the electric window openers at the particular instance can be realized with high reliability and without restrictions to the operating possibilities:

In particular, just one operating element is required in each case for operating the two electric window openers on one side of the motor vehicle (and so no additional operating elements are required), which is associated with little complexity for production and low costs; owing to the simple operating philosophy brought about by this means (the operating elements can be operated in a simple manner), the operator will intuitively undertake the correct operation.

Furthermore, visually unattractive and functionally unnecessary positions of the window panes can be avoided by the positive control of the rear window pane (sequential raising operation of front window pane and rear window pane, joint or sequential lowering operation of front window pane depending on the position of the rear window pane and the roof of the motor vehicle), but nevertheless all of the functionally required positions of the window panes can be realized in a simple manner (even in convertibles or coupés); in particular, it is possible, in a simple manner, in the case of motor vehicles having a movable roof, for all four window panes to be closed when the roof of the motor vehicle is open (optimum avoidance of drafts) and for all four window panes to be open when the roof of the motor vehicle is closed (“coupe opening”) or for just the rear window panes on their own to be open (cross ventilation).

The operation of the window openers for moving the window panes is independent of the operator; the same activity can be realized both from the driver's side and from the front passenger's side, i.e. all of the window panes can be operated equally well both by the driver and by the front passenger.

The method will be explained with reference to an exemplary embodiment in conjunction with the drawing, in which the FIGURE shows a flow diagram for controlling the window panes.

In order to bring about the electric action of the window openers of a motor vehicle having a movable roof (for example, a convertible or a roadster), an electric driving unit as the window opener drive is provided with a permanently excited d.c. motor of the electric motor (nominal power 100 W, for example), a transmission placed on the electric motor, control cables for moving the window panes and an electronic module which is integrated in the door controller of the motor vehicle. The window openers are operated via two operating elements which are arranged in the front compartment of the motor vehicle and are designed as window opener switches, one such operating element being provided for each operator (i.e. for the driver and for the front passenger). The respective operating element is provided for operating both window openers and therefore for both window panes on one side of the motor vehicle, i.e. both for the front window pane and for the rear window pane on one side of the motor vehicle.

According to the FIGURE, the following sequence is provided with the actuation of one of the two operating elements for controlling the window openers in order to move the corresponding front window pane FWP and the associated rear window pane RWP:

Interrogation of the Direction of Movement:

The operator's intention to close the window (front window and rear window) with a raising operation for the window pane or to open the window (front window and rear window) with a lowering operation of the window pane is detected via the position of the operating element: if a closing process of the windows and therefore a raising operation of the window panes is requested, firstly, in a sequential sequence, the corresponding front window pane (FWP) of the motor vehicle is raised (automatically or manually) for as long as the requirement remains in existence (either by permanent manual actuation of the operating element or by means of the automatic function, depending on the selected mode of movement) and only with the front window of the motor vehicle closed (if the front window pane FWP is completely raised) with a requirement still existing is the associated rear window pane RWP of the motor vehicle also raised (manually) for as long as the requirement remains in existence (only possible by permanent manual actuation of the operating element); if, in contrast, an opening process of the windows and therefore a lowering operation of the window panes is requested, first of all, as criterion, the position of the roof of the motor vehicle (i.e. the closed state of the roof) is checked (this criterion is particularly of importance in the case of motor vehicles having a movable roof, in which the roof can take up different positions, such as convertibles, roadsters etc.).

Interrogation of the Position of the Roof (of the Roof State):

The position of the roof (the closed state or open state of the roof) is detected by means of suitable sensors or switches, for example by means of limit switches. If the roof of the motor vehicle is open (in particular in convertibles, roadsters or similar motor vehicles) when an opening process of the windows and therefore a lowering operation of the window panes is requested, the front window pane FWP and the associated rear window pane RWP of the motor vehicle are lowered together for as long as the request remains in existence (in the case of the front window pane FWP, either by permanent manual actuation of the operating element or by means of the automatic function, depending on the selected mode of movement; in the case of the rear window pane RWP, only by means of the automatic function); if, in contrast, the roof of the motor vehicle is closed (for example, this is always the case with saloons), the position of the rear window pane RWP of the motor vehicle (the closed state of the rear window) is checked as a further criterion.

Interrogation of the Position of the Rear Window Pane RWP:

The position of the rear window pane RWP (the closed state or open state of the rear window pane RWP) is detected by means of suitable sensors or switches, for example by means of Hall sensors. If, upon a requested lowering of the window panes and when the roof is closed, the rear window pane RWP of the motor vehicle is not in the upper end position, i.e. the rear window of the motor vehicle is not completely closed, the front window pane FWP and the associated rear window pane RWP of the motor vehicle are lowered together for as long as the request remains in existence (in the case of the front window pane FWP, either by permanent manual actuation of the operating element or by means of the automatic function, depending on the selected mode of movement; in the case of the rear window pane RWP, only by means of the automatic function); if, in contrast, the rear window pane RWP of the motor vehicle is in the upper end position, i.e. the rear window of the motor vehicle is completely closed, firstly, in a sequential sequence, the corresponding front window pane FWP of the motor vehicle is lowered for as long as the request remains in existence (either by permanent manual actuation of the operating element or by means of the automatic function, depending on the selected mode of movement) and only with the front window of the motor vehicle completely open (with the front window pane FWP lowered completely) and with the request still in existence is the associated rear window pane RWP of the motor vehicle also automatically lowered for as long the request remains in existence.

The following chronological sequences are produced as a function of the corresponding request (actuation of the window opener switches as operating element):

Actuation of the Window Opener Switches “Manually Up”:

The front window pane FWP of the motor vehicle is first of all raised manually (at maximum until its upper end position is reached) and then, if the request still exists or is renewed, the associated rear window pane RWP of the motor vehicle is raised manually (at maximum until its upper end position is reached)

Actuation of the Window Opener Switches “Automatically Up”:

The front window pane FWP of the motor vehicle is first of all raised automatically (at maximum until its upper end position is reached) and then, if the request still exists or is renewed, the associated rear window pane RWP of the motor vehicle is raised manually (at maximum until its upper end position is reached)

Actuation of the Window Opener Switch “Manually Down”:

When the roof is open or the roof is closed and the rear window is not completely closed, the front window pane FWP of the motor vehicle is lowered manually (at maximum until its lower end position is reached), at the same time as the associated rear window pane RWP of the motor vehicle is automatically lowered (at maximum until its lower end position is reached); when the roof is closed and the rear window completely closed, first of all the front window pane FWP of the motor vehicle is lowered manually (at maximum until its lower end position is reached) and then, if the request is still in existence or is renewed, the associated rear window pane RWP of the motor vehicle is automatically lowered (at maximum until its lower end position is reached).

Actuation of the Window Opener Switch “Automatically Down”:

When the roof is open or the roof is closed and the rear window is not completely closed, the front window pane FWP of the motor vehicle is lowered automatically (at maximum until its lower end position is reached), at the same time as the associated rear window pane RWP of the motor vehicle is automatically lowered (at maximum until its lower end position is reached); when the roof is closed and the rear window completely closed, first of all the front window pane FWP of the motor vehicle is lowered automatically (at maximum until its lower end position is reached) and then, if the request is still in existence or is renewed, the associated rear window pane RWP of the motor vehicle is automatically lowered (at maximum until its lower end position is reached).

Accordingly, a raising operation of the two window panes on one side of the motor vehicle always takes place sequentially; a lowering of the two window panes on one side of the motor vehicle takes place simultaneously when the roof is open or roof is closed and a rear window pane RWP is not in the upper end position (when a rear window is not completely closed), and, in contrast, takes place sequentially when the roof is closed and a rear window pane RWP is in the upper end position (when a rear window is completely closed).

In the case of the front window, the automatic function is possible both in the event of the raising operation of the front window pane FWP (closing process of the front windows) and also in the event of a lowering operation of the front window pane FWP (opening process of the front windows); in the case of the rear window, the automatic function is not possible in the event of a raising operation of the rear window pane RWP (closing process of the front windows), and, in the event of a lowering operation, is always realized when the roof is open or when the roof is closed and a rear window pane RWP is not in the upper end position, but, if the roof is closed and a rear window pane RWP is in the upper end position, is only realized if the front window pane FWP is already in the lower end position.

1. A method for operating the electric window openers of a motor vehicle, characterized in that the window openers for moving the front window pane (FWP) and the rear window pane (RWP) on one side of the motor vehicle are operated by the actuation of a single operating element, and in that the sequence for moving the front window pane (FWP) and the rear window pane (RWP) is controlled as a function of the selection made by operating element of the direction of movement and of the mode of movement of the window panes and of the position of the rear window pane (RWP).

2. The method as claimed in claim 1, characterized in that in motor vehicles having a movable roof, the sequence for moving the front window pane (FWP) and the rear window pane (RWP) is controlled as a function of the position of the roof of the motor vehicle.

3. The method as claimed in claim 1 or 2, characterized in that if the closing direction is selected by the operating element as the direction of movement, firstly the front window pane (FWP) and then the rear window pane (RWP) is raised in a sequential raising operation.

4. The method as claimed in claim 3, characterized in that if the automatic function is selected by the operating element as the mode of movement, only the front window pane (FWP) is automatically raised.

5. The method as claimed in claim 1 or 2, characterized in that if the opening direction is selected by the operating element as the direction of movement when the roof is closed and the rear window completely closed, firstly the front window pane (FWP) and then the rear window pane (RWP) is lowered in a sequential lowering operation.

6. The method as claimed in claim 1 or 2, characterized in that if the opening direction is selected by the operating element as the direction of movement when the roof is open or when the roof is closed and the rear window is not completely closed, the front window pane (FWP) and the rear window pane (RWP) are simultaneously lowered in a common lowering operation.

7. The method as claimed in either of claims 5 and 6, characterized in that the rear window pane (RWP) is lowered automatically.

8. The method as claimed in one of claims 1 to 7, characterized in that the rear window pane (RWP) is not moved in a sequential raising operation or a sequential lowering operation until the front window pane (FWP) has reached its particular end position and the particular direction of movement is selected by the operating element.
